(19) United States
(12) Patent Application Publication
(10) Pub. No.: US 2014/0316084 A1
(43) Pub. Date: Oct. 23, 2014

(54) CATALYST SYSTEM FOR POLYMERIZATION OF PROPYLENE

(71) Applicants: Harshad Ramdas Patil, Surat (IN); Priyanshu Bharatkumar Vyas, Surat (IN); Virendrakumar Gupta, Navi Mumbai (IN)

(72) Inventors: Harshad Ramdas Patil, Surat (IN); Priyanshu Bharatkumar Vyas, Surat (IN); Virendrakumar Gupta, Navi Mumbai (IN)

(73) Assignee: Reliance Industries Limited, Maharashtra (IN)

(21) Appl. No.: 14/117,336

(22) PCT Filed: May 8, 2012
(86) PCT No.: PCT/IN12/00335

§ 371 Date: Jul. 9, 2014

(30) Foreign Application Priority Data
May 13, 2011 (IN) 1468/MUM/2011

(51) Int. Cl. C08F 110/06

(52) U.S. Cl. CPC C08F 110/06
USPC 526/125.3; 502/127; 526/351

(57) ABSTRACT

The present invention relates to a catalyst system for polymerization of propylene, process for preparing polypropylene and to polypropylene prepared by said process. The dual external donor composition of present invention has synergistic effects. It improves the efficiency of polymerization process and product properties for homo grade of polypropylene.

### FIELD OF THE INVENTION

The present invention relates to a catalyst system for polymerization of propylene, process for preparing polypropylene and to polypropylene prepared by said process. The present invention in particular relates to novel external donor system provided in said catalyst system that improves the efficiency of polymerization process and product properties for homo grade polypropylene.

### BACKGROUND OF THE INVENTION

Polymerization of propylene is carried out in presence of catalyst system consisting of titanium supported on magnesium dichloride (Ziegler Natta type procatalyst) carrying internal donor, an organo aluminium co-catalyst and an external electron donor. Type of internal donor used in procatalyst synthesis governs type of external donor to be used during polymerization process along with co-catalyst. Generally monoester catalyst system exhibits lower to medium productivity. It means higher specific consumption of procatalyst, co-catalyst and external donor, high residual content leading to less purity of polypropylene, operational problem like tripping of cycle gas compressor (CSG), high carry over of polymer particles in cycle gas in case of fluidized bed polymerzation, lower stiffness of polypropylene and increased oligomer contents. There is also limitation on xylene soluble content or XS (1.5 wt % max) with sustained productivity (i.e productivity reduces with reduction of XS) which can be achieved using monoester catalyst system with known external donor system. These all are the results which can further be improved.

Concept of using mixed external donor system for monoester catalyst system is known in the art. Variations in the type of external donors in mixtures and composition affect the efficiency of polymerization process and product characteristics.

WO2009141831A2 discloses the use of a combination of paraisopropoxy ethylbenzaote, cyclohexyl methyl dimethoxy silane in presence of a nitrogen compound as external donor during propylene polymerization. This combination narrows down molecular weight distribution (MWD) of polypropylene with higher productivity at approximately 3 wt % xylene soluble. The present invention provides a composition without use of nitrogen containing donor. The invented mixed external donor provides higher productivity at lower xylene soluble (0.8-1.0 wt %) and broader MWD which is required to increase stiffness of polypropylene for application like injection molding, thermoforming application etc.

WO2009116056A2 discloses the use of ethyl-4-isopropoxy benzoate as the only selectivity control agent.

U.S. Pat. No. 7420021 and US20080319146 disclose combination of ethyl p-ethoxybenzoate and dicyclopentyldimethoxysilane as external donor. The mentioned mixture is self-extinguishing in nature i.e. polymerization activity reduces with increasing temperatue of the reaction and only improvement in productivity can be observed at bench scale unit.

Despite the various catalyst and processes disclosed, there remains a need in the art to provide a synergistic catalyst composition for the polymerization of propylene wherein the catalyst composition has added advantage of improved productivity, less hydrogen and selectivity control agent (SCA) consumption with broad molecular weight distribution of polypropylene, lower XS achievement with sustained productivity of catalyst and high stiffness of polypropylene compared to the prior art.

Accordingly, improvement in the catalyst system productivity at lower XS and reduction in the hydrogen and selectivity consumption during polymerization and better stiffness through the changes in external donor system for monoester containing procatalyst system is required, which is achieved by utilizing the catalyst system and process of the present invention.

### OBJECTS OF THE INVENTION

An object of the present invention is to provide a catalyst system for the polymerization of propylene.

It is also an object of present invention to provide a gas phase process for polymerization of propylene with improved productivity, less hydrogen and selectivity controlling agent (SCA) consumption. The polypropylene has broad molecular weight distribution, lower XS and higher stiffness (or flexural modulus).

### STATEMENT OF THE INVENTION

The present invention relates to a catalyst system for polymerization of propylene.

The invention also relates to a gas phase process for polymerization of propylene in the presence of catalyst system and the polypropylene with broad molecular weight distribution and better stiffness than polypropylene with external donor used in prior art with monoester catalyst system.

### SUMMARY OF THE INVENTION

The present invention relates to a catalyst system for polymerization of propylene.

The invention also provides an external donor system that improves the efficiency of polymerization process and product properties for homo grade of polypropylene.

In an embodiment said catalyst system comprises solid magnesium supported titanium procatalyst carrying an internal donor, an organoaluminium co-catalyst and mixture of paraisopropoxy ethylbenzoate and dicylopentyl dimethoxy silane as external donor.

In another embodiment said procatalyst comprises 2.4 to 3.4 wt % Ti, 17 to 18 wt % Mg, 13 to 18 wt % ethylbenzoate and 0.1 to 0.5 wt % ethoxy.

In another embodiment said internal donor is monocarboxylic acid ester. In preferred embodiment said monocarboxylic acid ester is ethyl benzoate.

In another embodiment said organoaluminium co-catalyst is triethyl aluminium. In another embodiment said paraisopropoxy ethylbenzoate and dicylopentyldimethoxy silane are present in the range of 90:10 to 80:20 (mole basis) with preferred ratio of 90:10 on mole basis.

In another embodiment molar ratio of co-catalyst to external electron donor is in the range of 2 to 6, preferably in the range of 2 to 4.5 and the molar ratio of co-catalyst to procatalyst is in the range of 40 to 260.

The invention further provides a gas phase process for the polymerization of propylene in the presence of said catalyst system.

In another embodiment the invention provides a gas phase process which results into lower XS of polypropylene with sustained productivity of catalyst.

In another embodiment the process for polymerization of propylene is carried out in slurry phase or in bulk phase.

In an embodiment the present invention encompasses a gas phase process for polymerization of propylene using dual external donor system which comprises contacting the solid magnesium supported titanium procatalyst, co-catalyst and external donor system with propylene and hydrogen as chain controlling agent under fluidized bed condition,

wherein the bed weight is in the range of 30 to 32 kg, production rate in range of 20-25 kg/hr, superficial gas velocity is in the range of 0.28 to 0.35 m/s, monomer and hydrogen partial pressure of reactor is in the range of 70-72 and 4-6% respectively, reactor total pressure of 30-33 Bar, co-catalyst to procatalyst molar ratio is in the range of 40-260 preferably 40-50, co-catalyst to electron donor molar ratio is in the range of 2-6 preferably 2-4.5.

Still another embodiment of present invention provides a polypropylene having broad molecular weight distribution and high flexural modulus especially for thermoforming applications.

### DETAILED DESCRIPTION OF THE INVENTION

The present invention relates to a catalyst system for polymerization of propylene, process for preparing polypropylene and to polypropylene prepared by said process. The present invention in particular relates to novel external donor systems provided in said catalyst system that improves the efficiency of polymerization process and product properties for homo grade of polypropylene.

The catalyst system comprises a solid magnesium supported titanium procatalyst, co-catalyst and mixture of paraisopropoxy ethylbenzoate and dicylopentyl dimethoxy silane as external donor.

The procatalyst comprises 2.4 to 3.4 wt % Ti, 17 to 18 wt % Mg, 13 to 18 wt % ethylbenzoate and 0.1 to 0.5 wt % ethoxy. The ethoxy (—OC₂H₅) indicates residual/unconverted magnesium alkoxide moiety of precursor which is converted to magnesium dichloride support during catalyst synthesis process.

The mixture of external donors when used along with monoester based internal donors during polymerization of propylene involving Ziegler Natta catalyst (magnesium supported titanium catalyst, an organoaluminium co-catalyst) gives higher productivity, lower co-catalyst and hydrogen consumption (as shown in Example 2). The molar ratio of paraisopropoxy ethylbenzoate and dicylopentyldimethoxy silane used is in the range of 90:10 to 80:20 with preferred ratio of 90:10.

The dual external donor system of present invention provides synergistic effects over the dual external systems known in the art. It gives higher productivity, lower co-catalyst and hydrogen consumption when used in the polymerization reaction of propylene.

This novel composition of dual external donor system provides improved productivity and better hydrogen response compared to combinations known in the art. The polypropylene produced using such composition has broad molecular weight distribution which is an important and useful property Of homo polypropylene used for injection molding or thermoforming application. The synergistic dual external donor composition comprises paraisopropoxy ethylbenzoate and dicylopentyldimethoxy silane which exhibit lower XS (less than 1.5 wt %) with higher productivity and product having high flexural modulus for homo polypropylene grade as compared to composition comprising paraethoxy ethylbenzoate and dicylopentyldimethoxy silane as well as paraisopropxy ethylbenzoate as standalone external donor. Results of polymerization performance and product characteristics for various external systems such as PEEB [ethyl(p-ethoxy) benzoate], PIPEB [paraisopropxy ethylbenzoate], PEEB+DCPDMS [paraethoxy ethylbenzoate and dicylopentyldimethoxy silanee] and PIPEB+DCPDMS [paraisopropoxy ethylbenzoate and dicylopentyldimethoxy silane] is provided in Example 1. The detail gas phase study is detailed in Example 2.

A gas phase process for polymerization of propylene using the dual external donor system of present invention comprises contacting the solid magnesium supported titanium catalyst, co-catalyst and catalyst system comprising the dual external donor composition with propylene and hydrogen as chain controlling agent under fluidized bed condition. The gas phase polymerization conditions such as bed weight/throughput, superficial gas velocity, monomer and hydrogen partial pressure of reactor, co-catalyst/procatalyst titanium molar ratio, co-catalyst to external donor molar ratio were optimized to achieve maximum catalyst efficiency with desired operational targets. In the process the bed weight is in the range of 30 to 32 kg, production rate in range of 20-25 kg/hr, superficial gas velocity is in the range of 0.28 to 0.35 m/s, monomer and hydrogen partial pressure of reactor is in the range of 70-72 and 4-6% respectively, reactor total pressure of 30-33 Bar, co-catalyst to procatalyst molar ratio is in the range of 40-260 preferably 40-50, co-catalyst to electron donor molar ratio is in the range of 2-6 preferably 2-4.5.

The homo polypropylene grade evaluated for molecular weight distribution, mechanical properties etc for required application advantage as shown in Example 2. Broad molecular weight distribution is useful for injection molding or thermoforming application. Higher flexural modulus is effective for high stiffness application. Higher productivity of catalyst is desirable since it gives high purity of polypropylene

The process parameters of present invention gives improved catalyst productivity, reduced hydrogen consumption and SCA consumption resulting in better product characteristics in terms of molecular weight distribution, mechanical properties compared to paraethoxy ethylbenzoate (Example 2). The process parameter for gas phase process is such that it results in lower XS of polypropylene with sustained productivity of catalyst.

The homo polypropylene thus produced has broad molecular weight distribution and high flexural modulus (FM) especially for thermo forming application. High flexure modulus in the present invention refers to a value higher than 1650 MPa. The term “broad” in broad molecular weight distribution signifies comparison of polypropylene of the present invention with the polypropylene prepared by a process using PEEB [ethyl(p-ethoxy) benzoate] as an external donor. The MWD of polypropylene prepared by a process using PEEB is in the range of 5-5-6.0, whereas in the present invention it is higher viz., 6.0-6.5.

The present invention is being further defined by way of examples herein below, which have been provided for illustration purpose and therefore should not be construed to limit the scope of invention.

### EXAMPLE 1

### Polymerization Performance and Product Characteristics for PEEB, PIPEB, PEEB/DCPDMS and PIPEB/DCPDMS by Slurry Polymerization

The polymerization was carried out in the slurry phase using 65 to 70 g of a procatalyst having a composition of 2.8 to 3.4 wt % Ti, 17 to 18 wt % Mg, 14 to 16 wt % of ethyl benzoate (internal donor), 1.3 ml of triethyl aluminium co-catalyst (diluted to 10 volume % in n-decane) and a mixture of external electron donors in a ratio of 90:10 (as listed in table 1 and diluted to 5 volume % in n-decane). The procatalyst, the mixture of external donors and the co-catalyst were added along with n-hexane solvent (2 L) into a preheated moisture-free stainless steel jacketed 4 liter semi batch stirred tank reactor containing a magnetic stirrer at 400 rpm. Procatalyst and co-catalyst were added in such amounts as to have a co-catalyst/procatalyst molar ratio of 250±10 and a co-catalyst/external donor molar ratio of 3±0.1. 240 ml of hydrogen was also added into the reactor under ambient conditions (30±2 ° C.). Propylene gas was introduced into the reactor, the reactor pressure was raised to 5.0±0.2 kg/cm² and the reactor temperature was raised to 70±2° C. Polymerization of propylene was carried out in the slurry phase for 1 hour maintaining reactor pressure of 5.0±0.2 kg/cm². Reaction was stopped by addition of acidified methanol after 1 hour and reactor content was cooled to 40° C. After 1 hour of reaction, hexane was removed and polymer was collected/dried. Productivity of catalyst was calculated based on polymer yield and amount of catalyst used. The amount of catalyst was calculated following titanium estimation method. The polymerization productivity of the monoester catalyst systems in different experiments using different mixtures of external electron donors is given in Table 1.

TABLE 1
Polymerization performance and product characteristics for PEEB,
PIPEB, PEEB/DCPDMS and PIPEB/DCPDMS by slurry polymerization

| | Productivity | | | |
|---|---|---|---|---|
| | (KgPP/gcat) ± | Xylene soluble | MFI (g/10 min) ± | Teal/Donor |
| Donor System | 0.1 | (wt %) ± 0.1 | 0.1 | (Mole ratio) |
| PEEB | 2.7 | 2.0 | 1.5 | 3 |
| PIPEB | 3.1 | 2.1 | 2.3 | 3 |
| % increase in | 15% | | | |
| productivity from | | | | |
| PEEB to PIPEB) | | | | |
| PEEB + D | 3.2 | 1.9 | 1.3 | 3 |
| % increase in | 18% | | | |
| productivity from | | | | |
| PEEB to PEEB + D | | | | |
| PIPEB + D | 4.7 | 2.0 | 3.4 | 3 |
| % increase in | 51% | | | |
| productivity from | | | | |
| PIPEB to PIPEB + D | | | | |

Results of study indicate that PIPEB+D system exhibits higher productivity compared to PEEB, PIPEB or PEEB+D system at comparable XS levels.

### EXAMPLE 2

### Polymerization Performance and Product Characteristics For PEEB and PIPEB/DCPDMS by Gas Phase Polymerization

The gas phase reactor having 20-25 kg/hr throughput was used for production of homo polypropylene. The monoester catalyst slurry, external donor and and triethyl aluminum was feed into system. The reactor pressure was maintained at 30-33 Kg/Cm² (70-75% propylene), Bed weight of 15-25 Kg & specific gas velocity of 0.32-0.35 m/s was maintain. Co-catalyst/Ti of catalyst mole ratio of 40-50 was maintained. The polypropylene powder was continuously evaluated for MFI & XS. Polymerization and product performance are tabulated below in Table-2

TABLE 2
Gas phase polymerization performance of PIPEB + D and PEEB system

| Parameters | Units | PEEB | PIPEB + D |
|---|---|---|---|
| Productivity | KgPP/gcat | 3.4 | 5.2 |
| H₂/C₃ | Mole ratio | 0.085 | 0.0825 |
| Teal/Donor | Mole ratio | 2.3 | 4.1 |
| XS | Wt % | 3.5-3.6 | 0.9 |
| MFI | g/10 min | 20.5 | 21.0 |
| Teal/Ti | Mole ratio | 45 | 45 |
| Flexural | MPa | 1610 | 1740 |
| modulus | | | |
| Izod impact | J/m | 27.2 | 20.1 |
| strength | | | |
| Residual Ti | ppm | 5.8 | 2.6 |
| Molecular | | Mₙ = 8.7 × 10⁴ | Mₙ = 8.5 × 10⁴ |
| weight study by | | M_{w} = 4.7 × 10⁵ | M_{w} = 5.2 × 10⁵ |
| RDA | | M_{z} = 2.5 × 10⁶ | M_{z} = 2.9 × 10⁶ |
| | | MWD (PD) = 5.4 | MWD (PD) = 6.1 |

Above results indicate that productivity of PIPEB+D system is higher than PEEB. The flexural modulus of polypropylene produced using PIPEB+D is higher by 130 units compared to polypropylene produced by PEEB. Extrusion was carried out without addition of nucleating agent. Izod strength of polypropylene has remained comparable. Also MWD study indicated broad molecular weight distribution for PP with PIPEB+D system.

1. A catalyst system for polymerization of propylene comprising:
(a) a magnesium supported titanium procatalyst carrying internal donor;
(b) organoaluminium co-catalyst; and
(c) mixture of paraisopropoxy ethylbenzoate and dicyclopentyl dimethoxy silane as external donor.

2. The catalyst system as claimed in claim 1, wherein the said procatalyst comprises 2.4 to 3.4 wt % Ti, 17 to 18 wt % Mg, 13 to 18 wt % ethylbenzoate and 0.1 to 0.5 wt % ethoxy.

3. The catalyst system as claimed in claim 1, wherein the internal donor is monocarboxylic acid ester.

4. The catalyst system as claimed in claim 3, wherein monocarboxylic acid ester is ethyl benzoate.

5. The catalyst system as claimed in claim 1, wherein the organoaluminium co-catalyst is triethyl aluminium.

6. The catalyst system as claimed in claim 1, wherein the molar ratio of paraisopropoxy ethylbenzoate to dicyclopentyldimethoxy silane is in the range of 90:10 to 80:20.

7. The catalyst system as claimed in claim 1, wherein molar ratio of co-catalyst to external donor is in the range of 2 to 6.

8. The catalyst system as claimed in claim 1, wherein molar ratio of co-catalyst to procatalyst is in the range of 40 to 260.

9. A process for polymerization of propylene comprising contacting propylene with the catalyst system of claim 1.

10. The process as claimed in claim 9, wherein the process is carried out in slurry phase, in gas phase or in bulk phase.

11. (canceled)

12. A polypropylene having broad molecular weight distribution in the range of 6.0-6.5 and flexure modulus higher than 1650 Mpa prepared by the process of claim 9.

13. A method of using the polypropylene as claimed in claim 12 comprising a step of injection molding or thermoforming.

14. (canceled)

15. The catalyst system as claimed in claim 6, wherein the molar ratio of paraisopropoxy ethylbenzoate to dicyclopentyldimethoxy silane is 90:10.

16. The catalyst system as claimed in claim 7, wherein molar ratio of co-catalyst to external donor is in the range of 2 to 4.5.
